(19) United States
(12) Patent Application Publication
(10) Pub. No.: US 2012/0260183 A1
(43) Pub. Date: Oct. 11, 2012

(54) Monitoring Status of Selected Entities

(76) Inventor: James F. Rogers, Dallas, TX (US)

(21) Appl. No.: 13/083,148

(22) Filed: Apr. 8, 2011

(51) Int. Cl. G06F 3/01

(52) U.S. Cl. 715/736

(57) ABSTRACT

A system allows users to view and analyze the status of one or more selected entities by obtaining status information associated with the selected entities and displaying the information with identifiers associated with each of the selected entities. Various embodiments of the disclosure can provide different and additional methods of displaying, analyzing, and tracking status information associated with the selected entities. Entities can selectively restrict some or all status information from being viewed by some or all users. In addition, an entity can be a user, who can self-report status information to be viewed by the user, other users, or other entities.

### FIELD

The present invention relates in general to information retrieval and display, and more particularly to obtaining and displaying information related to the status of selected people or other entities.

### BACKGROUND

Currently available social networking websites and programs enable users to interact with others by posting information to a website or social media account. Other users can access the posted information by downloading the webpage to their computer or handheld device. In some cases, a user can access particular information about another user in whom they are interested by signing into the user's own social media account, and navigating to a webpage that includes information about the other user. The webpage including the other user's information may have various information about the user automatically displayed, while other information is not displayed unless the user takes further action via menus, searches, or the like.

A variety of information can be stored and displayed on social networking services, including but not limited to physical characteristics, preferences (favorite films, television broadcasts, musical and literary works), educational history, occupational history, and contact information. In some instances, a user's historical status updates are stored by the website on the webpage, or they can be accessed by the webpage.

Some social networking services allow a user to update information about the user's present status. For example, Twitter allows users to “tweet” (i.e. broadcast) information for access by numerous other users. Often, although not always, this information relates to an activity in which a user is engaged, is about to undertake, or has just completed. User's also broadcast information related to current thoughts, ideas, feelings, or the like. Such information is usually limited to text, video, or hyperlinks.

However, searching for and extracting information using currently available social networking websites can be time consuming and cumbersome. And obtaining desired information from social networking services in which information is broadcast can require a user to sift through a large amount of unwanted information. Thus, currently available technology is less than perfect.

### SUMMARY

Various embodiments of the present disclosure allow a user to obtain selected status information for a desired group of people, friends, groups, or the like, in one or more graphs, tables, or charts that are automatically displayed upon a user signing onto a social networking service, activating a social networking program, or navigating to a particular webpage. In at least one embodiment, a table includes a row for each person selected for status monitoring, and a column for each monitored status item. The table's cells can be used to display a numerical ranking representing the most recent status for each person/status-item combination. Each cell, or number within the cell can be color coded to indicate a general status level. For example, red may be assigned to numbers 1-4, yellow may be assigned to numbers 5-8, and green may be assigned to numbers 9-10.

In one aspect of the disclosure, status information associated each entity in a group of selected entities, including status indications that represent a self-reported status of the entity, is obtained and displayed, along with a corresponding identifier associated with each selected entity, in a first graphical depiction. The display of the first graphical depiction can occur upon initializing a webpage. Additional graphical depictions, such as a line graph, that show variation of a status indication against a variable, such as time, can be displayed in a pop-up field. A status indication can be set at a default value, which can be altered and stored. The status information can be selected from a group consisting of status category identifiers, including an entity's physical state, mental state, overall mood, attitude, sleep state, relationship status, and fitness. Also, additional status indications not originally displayed in the first graphical depiction can be displayed in a pop-up field when a cursor hovers over a status indication displayed in the first graphical depiction.

In another aspect of the disclosure, a computer-readable medium includes a program of computer executable instructions, including an instruction to obtain status information associated with each entity in a group of selected entities, and an instruction to display a first graphical depiction that includes an identifier associated with each of the selected plurality of entities and the plurality of status indications associated with each of the selected plurality of entities. Status information can include status indications that represent the self-reported status of a respective entity. The program can include an instruction to display, in a pop-up field, additional graphical depictions, such as a line graph, that shows variation of a status indication against a variable, such as time. The program can also include an instruction to set a status indication at a default value, an instruction to alter the default status indication; an instruction to store the altered status indication; an instruction to select the status information from a group consisting of status information associated with an entity's physical state, mental state, overall mood, attitude, sleep state, relationship status, and fitness; an instruction to display additional status indications in a pop-up field when a cursor hovers over a status indication displayed in the first graphical depiction; and an instruction to display the first graphical depiction in association with initializing a webpage.

In another aspect of the disclosure, an apparatus includes a device that is configured to obtain status information associated with each entity in a group of selected entities and an instruction to display a first graphical depiction that includes an identifier associated with each of the selected plurality of entities and the plurality of status indications associated with each of the selected plurality of entities. Status information can include status indications that represent the self-reported status of a respective entity. The device can be configured to display the first graphical depiction in association with initializing a webpage. The device can also be configured to display, in a pop-up field, additional status indications or additional graphical depictions, such as line graphs of the variation of a status indicator against a variable or text boxes. Pop-up fields can be displayed when a cursor hovers over specific item in the first graphical depiction, such as a status indication or an identifier associated with an entity. Furthermore, the device can be configured to set a status indication at an initial default value, alter the default status indication, and store the altered status indication. The device can also be configured to select the status information from a group consisting of status information associated with an entity's physical state, mental state, overall mood, attitude, sleep state, relationship status, and fitness.

### BRIEF DESCRIPTION OF THE DRAWINGS

Aspects of this disclosure will become apparent upon reading the following detailed description and upon reference to the accompanying drawings, in which like references may indicate similar elements:

FIG. 1 is a diagram illustrating a website server/webpage/user environment according to various embodiments of the present disclosure;

FIG. 2 is a diagram illustrating a first graphical depiction according to various embodiments of the present disclosure;

FIG. 3 is a diagram illustrating a first graphical depiction with a pop-up field containing additional information according to various embodiments of the present disclosure;

FIG. 4 is a diagram illustrating a first graphical depiction with a pop-up field containing a second graphical depiction according to various embodiments of the present disclosure;

FIG. 5 is a diagram illustrating a control window for a Status Tracker according to various embodiments of the present disclosure;

FIG. 6 is a diagram illustrating a control window for a Status Tracker Graph according to various embodiments of the present disclosure;

FIG. 7 is a flowchart illustrating a method for generating and displaying a graphical depiction of an identifier associated with an entity and status indications associated with the entity according to various embodiments of the present disclosure; and

FIG. 8 is a block diagram illustrating a hardware environment used to implement a computer according to various embodiments of the present disclosure.

### DETAILED DESCRIPTION

The following is a detailed description of embodiments of the disclosure depicted in the accompanying drawings. The embodiments are described in such detail as to clearly communicate to one of ordinary skill how to make and use the claimed invention. However, the amount of detail offered is not intended to limit the anticipated variations of embodiments; on the contrary, the intention is to cover all modifications, equivalents, and alternatives falling within the spirit and scope of the present disclosure as defined by the appended claims.

The Internet is a vast collection of global-spanning networks that communicate with each other by using protocols, such as the Transmission Control Protocol (TCP) and the Internet Protocol (IP). Via its networks, the Internet enables many computers, located at different sites around the world, to access information from each other.

The World Wide Web (i.e., the “WWW” or the “Web”) is the fastest growing part of the Internet. The Web works within a client/server model. Web client software runs on the Web client computers, and Web server software runs on the Web server computer. Web client software—known as the Web browser—interacts with both the user and the Web server software. In particular, the Web browser receives a Universal Resource Locator (URL) request from a user. The URL is a unique identifier for requested information. The Web browser then sends the URL request to the Web server software using Hypertext Transfer Protocol (HTTP). In response to the URL request, the Web server software locates and returns the requested information to the Web browser.

The Web contains websites made up of webpages that incorporate text, graphics, sound, animation, and other multimedia elements. Many webpages are formatted in a language called HyperText Markup Language (HTML). HTML controls the appearance of a webpage. Specifically, HTML controls how information, such as, text, images, and push-buttons are arranged on a webpage. Hypertext links connect the web pages to each other, and to any other pages, graphics, binary files, or multimedia files.

HTML is based on SGML (Standard Generalized Markup Language). SGML allows documents to describe their own grammar—that is, to specify a tag set used in the document, and to specify the structural relationships that those tags represent. SGML makes it possible to define different formats, for each document; to handle large and complex documents; and to manage large information repositories. Full SGML, however, contains many optional features that are not needed for Web applications.

HTML web pages incorporate a small set of tags in conformance with SGML. In general, HTML is well suited for hypertext, multimedia, and the display of small and reasonably simple documents.

A system according to various embodiments can be used to automatically display status information associated with one or more entities in the form of a graphical depiction, which can include, but is not limited to, a chart, a graph, a text box, an icon, or some other visual element, upon initialization of a webpage. Status information can include status indications that represent a self-reported status of the entity. An entity can include, but is not limited to, the user himself, another user, an individual, a group of individuals, an organization, a corporation, or some other collection of individuals or organizations. A status indication can include, but is not limited to, an indication of an entity's emotional state, mental state, physical state, frequency of sleep, overall mood or other similar status category identifiers, or the like.

Various embodiments enable a user to observe the statuses of a selected group of entities. For example, various embodiments generate a graphical depiction, such as a chart, that displays indicators identifying the selected group of entities, along with corresponding status indications associated with those entities. In some embodiments, the user can track his own statuses, either alone or with one or more entities. The status indications can be numerical values illustrating each entity's relative condition for a particular status on a ranking scale of 1-10 (10 being highest), although other suitable scales can be used. The status indications can also be presented as a color-coded numerical ranking scale (e.g., red may be assigned to numbers 1-4, yellow may be assigned to numbers 5-8, and green may be assigned to numbers 9-10), graphical icons, a selection from a range of short text phrases, an alphabetic or pictographic scale, or some other representation.

The status indications can be displayed in different types of charts, or other formats. For example, the status indications may be displayed to the user in the form of a spreadsheet, with identifiers associated with entities arranged in rows, status indication labels arranged in columns, or vice versa. Additional types of charts that can be used to present status indications to the user can include, but are not limited to, graphical charts, pie charts, bar diagrams, line graphs, or other types of charts or graphs. For example, the status indications associated with one or more entities might be displayed as one or more lines on a line graph that tracks the variation of the entities' respective status indications against a variable, such as time.

Certain embodiments include mitigating the need for a user to unnecessarily spend time trying to locate status information associated with selected entities. For example, the user can view the charts displaying status indications associated with the statuses of the selected entities automatically upon initialization of a webpage, or the statuses might be displayed after an affirmative action by the user, such as clicking an icon, button or other user-selectable object on the webpage. In another embodiment, some status indications may be displayed automatically, while others are displayed after an affirmative action by the user.

By generating status charts, graphs, or other status indications automatically upon initialization of a webpage, some embodiments allow a user to minimize the amount of time spent keeping track of the respective statuses of selected entities. For example, the user is relieved from being required to spend time performing any additional actions to access the information beyond initializing the webpage; the information is displayed as soon as the webpage initializes, or shortly thereafter. Furthermore, because some embodiments also enable a user to select which entities and which status indications associated with the respective entities are to be displayed, the user does not have to waste time on entities or statuses that are not important to the user.

Some embodiments enable users to quickly and efficiently analyze and interpret information associated with statuses of selected entities. For example, rather than require a user to take the time to study and interpret various different status indications to determine the respective statuses of each entity in a selected group, some embodiments provide status indications of a uniform type in a graphical depiction, thus enabling a user to easily compare and contrast an entity's status against the respective statuses of other entities. Or, through the use of a graphical depiction such as a line graph or text box, which can be displayed in a pop-up field, he can track the variation of one or more of that entity's status indicators over time. A pop-up field can include, but is not limited to, a field, text box, graphical icon, or some other element that can be displayed by an affirmative action by a user or entity, such as hovering a cursor over the indicator of an entity in another graphical depiction, automatically, or by some other means. For example, the graphical depiction may display status indications associated with an entity as sets of data points on one or more lines on a line graph that tracks the variation of the status indications against a variable, such as time.

Where the status indications displayed in the first, automatically displayed, graphical depiction may not provide all desired context information for a given status of an entity—for example, explaining why the entity has reported a certain status—some embodiments enable an entity to provide additional context-bearing status indications that can be displayed in a pop-up field when a user hovers a cursor over the otherwise ambiguous status indication associated with the given status, thereby enabling flexibility to provide context for easy user interpretation of complex statuses of entities.

In some embodiments, a first graphical depiction that features status information associated with the user can be displayed. For example, a first graphical depiction can include a chart that displays multiple categories of status information that the user can view and edit, including categories for which the user has not provided any information. In some embodiments, the first graphical depiction can be displayed on the user's own webpage for visitors to view, or it may be displayed only for the user. In some embodiments, a webpage can display second graphical depictions or additional status information of the user to the user or other entities. Furthermore, in some embodiments, the user can selectively restrict which entities, if any, may view or obtain some or all of the user's own status information. For example, the user may restrict the availability of some of his own status information to the status trackers of entities that meet certain criteria or clearance levels, including, but not limited to, entities identified by the user as part of a group of entities associated with a certain clearance level, such as an entity identified by the user as a “Chart Friend”. Multiple groups of entities, each with their own clearance levels, can be created and defined.

In some embodiments, the first graphical depiction can be displayed as part of a user's webpage. In other embodiments, the first graphical depiction can be displayed at another location, including, but not limited to, another webpage, a new tab or window in the user's web browser program, or in another computer program located on the user's end-user device or elsewhere. As the user hovers a cursor over the displayed first graphical depiction, a second graphical depiction, such as a graph that tracks status information associated with at least one entity against a variable, or additional status information associated with a displayed status indication in pop-up fields, can be displayed.

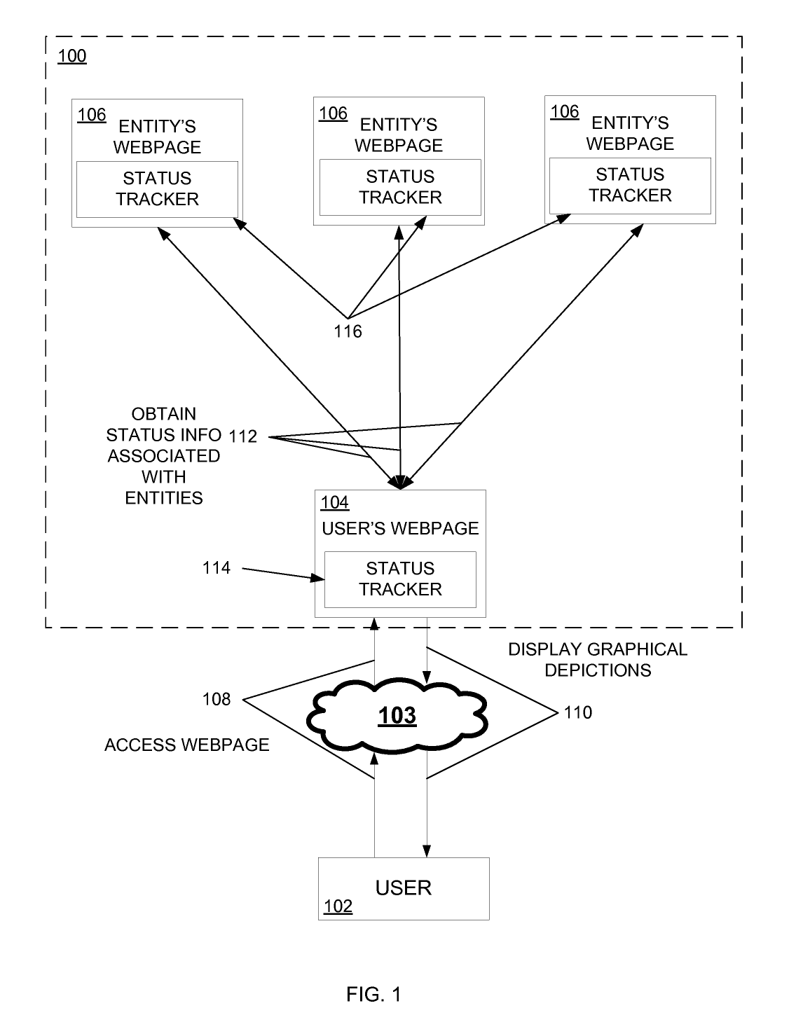

Referring first to FIG. 1, embodiments of the disclosure are illustrated and discussed. A website 100 includes, but is not limited to, a user's webpage 104, or one or more webpages 106 for one or more entities. The processing circuitry for the website 100 can be located in a server or some other device. The user 102 interacts with the user's webpage 104 via a broadcast network 103, which can include but is not limited to the Internet or a cellular network.

In some embodiments, the user's webpage 104 includes a Status Tracker 114, and other entities' respective webpages 106 each include a respective Status Tracker 116. Status Tracker 114 can be part of the programming code for the webpage 104, a software module for the website 100, a computer program for the website's 100 server, an independent software program, a part of an independent service provided by another source, such as another website or webpage, or some other type of program. In some embodiments, the Status Tracker 114 can be located on the website's 100 server and directed to control one or more webpages 106, including the user's webpage 104, or it can be located on the user's 102 end-user device, such as a computer, mobile device, or PDA and dedicated to one or more webpages. In other embodiments, Status Tracker 114 can be located on an independent server or at some other location.

In some embodiments, the user accesses the webpage 108, which activates Status Tracker 114 located in the user's webpage 104. The user 102 is, in at least one embodiment, not required to take any action to activate Status Tracker 114, although embodiments of Status Tracker 114 requiring some user action are possible and should be considered encompassed by this disclosure.

Status Tracker 114 obtains, or accesses, a list of selected entities for which the user 102 wants the Status Tracker 114 to display status information in a first graphical depiction. Status information can include status indications, such as numerical values illustrating each entity's relative condition for a particular status on a ranking scale of 1-10 (10 being highest), although other suitable scales can be used. The status indications can also be colors illustrating each entity's relative condition for a particular status on a color-coded numerical ranking scale (e.g., blue may be assigned to numbers 1-3, purple may be assigned to numbers 4-7, and pink may be assigned to numbers 8-10), graphical icons, a selection from a range of short text phrases, an alphabetic or pictographic scale, or some other representation. In other embodiments, the status indications can be customized by an entity including, but not limited to, a user monitoring the status information of other entities, a user self-reporting status information, or some other entity. Customization of the status indication can include, but is not limited to, altering a numerical ranking scale, altering the colors in a color-coded numerical ranking scale, a combination of the two, or some other alteration. The status information displayed in a first graphical depiction can include, but is not limited to, all status indications that can be displayed in a first graphical depiction, or it can be a specific set of status indications preselected by the user 102. For example, in some embodiments Status Tracker 114 may display any and all status indications that it can obtain; in other embodiments, the user 102 may restrict the status indications that are to be displayed to a selected group of status indications.

In some embodiments, Status Tracker 114 sends a query 112 to webpages 106 associated with selected entities for status tracking The status information from each entity can be provided to Status Tracker 114 from a number of sources, including but not limited to the respective entity's webpage 106, the respective entity's Status Tracker 116, or some other component of the website 100 or the server which stores the website. In some embodiments, the status information from each entity can be provided to Status Tracker 114 from some other source, including, but not limited to, an independent website or server, or an entity's end-user device.

Once the desired status information has been received by Status Tracker 114, Status Tracker 114, in some embodiments, generates or retrieves an identifier associated with each selected entity. Alternatively, each entity's Status Tracker 116 may store an entity-defined identifier provided to Status Tracker 114 along with the requested status information; furthermore, the website 100 may generate an identifier associated with each entity and provide it, in combination with or separate from the requested status information, to Status Tracker 114.

Status Tracker 114 can, in some embodiments, generate a first graphical depiction, such as a chart or spreadsheet, displaying an indicator for each selected entity along with the corresponding requested status information associated with each respective entity. For example, each row of a spreadsheet containing an indicator associated with a respective entity may include status information for the respective entity and each column of the spreadsheet may include status information associated with a specific status, such that a given cell may display specific status information associated with a respective status and a respective entity.

In some embodiments, the status information associated with an entity can include, but is not limited to, information associated with the entity's physical state, mental state, overall mood, attitude, sleep state, financial health, relationship status, and fitness. For example, some status information may indicate that an entity is in good physical shape; other status information may indicate that an entity is in a bad overall mood, is ill, is depressed, is not getting much sleep, is in a relationship, or some other state of being.

Status Tracker 114 can, in some embodiments, display the first graphical depiction as part of a user's webpage 104 which is transmitted 110 to the user 102 via the broadcast network 103. In other embodiments, Status Tracker 114 can display the first graphical depiction at another location, including, but not limited to, another webpage, a new tab or window in the user's web browser program, or in another computer program located on the user's 102 end-user device or elsewhere. As the user hovers a cursor over the displayed first graphical depiction, Status Tracker 114 can display a second graphical depiction, such as a graph, that tracks status information associated with at least one entity against a variable, or additional status information associated with a displayed status indication, in pop-up fields.

In some embodiments, Status Tracker 114 displays a first graphical depiction that features status information associated with the user 102. For example, Status Tracker can present the user 102 with a first graphical depiction, such as a chart, that displays multiple categories of status information that the user 102 can view and edit, including categories for which the user 102 has not yet provided any information. In some embodiments, the first graphical depiction can be displayed on the user's 102 own webpage 104 for visitors to view, or it may be displayed only for the user 102. In some embodiments, Status Tracker 114 can display second graphical depictions or additional status information of the user 102 to the user or other entities. Furthermore, in some embodiments, the user 102 can selectively restrict which entities, if any, may view or obtain some or all of the user's 102 own status information. For example, the user 102 may selectively restrict the availability of some of his own status information to the status trackers 116 of entities 106 that meet certain user 102—defined criteria or clearance levels, including, but not limited to, entities 106 identified by the user 102 as part of a group of entities associated with a certain clearance level, such as an entity 106 identified by the user 102 as a “Chart Friend”. Multiple groups of entities 106, each with their own clearance levels, can be created and defined. In some embodiments, restricting what status information is displayed in a first graphical depiction can be performed by an entity's Status Tracker 116 withholding any status information associated with the entity 106 that the user 102 does not have the necessary clearance level to view. In other embodiments, restricting what status information is displayed in a first graphical depiction can be performed by Status Tracker 114 receiving some or all of the selected entities' status information but not including in the first graphical depiction any status information that the user 102 does not have the necessary clearance level to view.

Status Tracker 114 can, in some embodiments, generate graphical depictions for multiple users. For example, Status Tracker 114 may simultaneously control the supply of status information and display of graphical depictions for multiple entities. Such an embodiment of Status Tracker 114 may control the display of graphical depictions for all users 102 on the website 100 from a location on the server of the website 100 or an independent server that is not controlled by the website 100, or some other location. Alternatively, Status Tracker 114 may be located on an end-user device and generate graphical depictions for one or more users who utilize the end-user device.

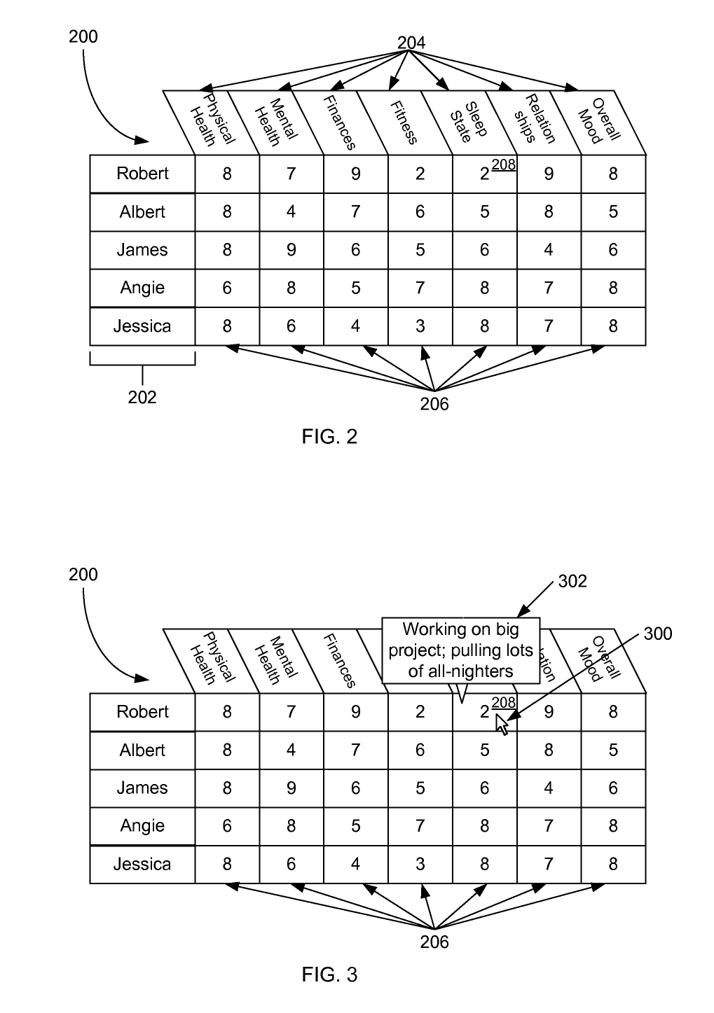

Referring to FIG. 2, embodiments of a first graphical depiction that displays various status information for selected entities are illustrated and discussed. In the illustrated embodiment, a chart 200 displays status information associated with selected entities, such as a group of entities selected by a user, a group of entities selected at random, or some other selection of entities. The illustrated embodiment of the chart 200 shows a spreadsheet; however, other embodiments of the chart 200 can include graphical charts, pie charts, bar diagrams, line graphs, or other types of graphical representations or images.

Selected entities are represented in the chart 200 by identifiers 202. In some embodiments, the user himself can be one of the selected entities. Status category identifiers are labeled in headers 204. Status indications associated with a selected entity are displayed in cells 206. In some embodiments, each cell 206 displays a single status indication, in the form of a numerical value illustrating a respective entity's relative condition for a particular status on a ranking scale of 1-10 (10 being highest), associated with a respective entity. For example, cell 208 includes a status indication associated with the status category of “Sleep State” of Robert, where the status indication provides a numerical value for the sleep state of “2” on a ranking scale of 1-10 (10 being highest), thereby indicating that Robert is not getting very much sleep at night. Various other types of status indications can be displayed in cells 206, including, but not limited to, colors on a color-coded ranking scale, graphical icons, a selection from a range of short text phrases, or an alphabetic or pictographic scale. In some embodiments, the chart 200 may be displayed by a user's Status Tracker automatically whenever the user initializes the user's webpage; in other embodiments, the chart 200 may be displayed upon an affirmative action by the user, including, but not limited to, selecting a button on the webpage or an independent computer program.

In some embodiments, cells 206, displaying status indications associated with one status, can display different types of status indications than cells 206 displaying status indications associated with a different status category. For example, cells 206 displaying status indications for “Overall Mood” may display numerical values on a ranking scale, while cells 206 displaying status indications for “Fitness” may display colors on a color-coded ranking scale. The chart 200 can be displayed by a Status Tracker automatically whenever the user initializes the user's webpage. In other embodiments, each cell 206 can display multiple status indications. For example, cells 206 displaying status indications for “Overall Mood” may display both a numerical value on a ranking scale and a color on a color-coded ranking scale.

In some embodiments, the cells 206 can be edited by a user. For example, where the user is one of the selected entities, the cells 206 associated with the user can be edited by the user, who can determine what status indications will be displayed in each cell 206. The status information entered into the cells 206 can be collected and displayed in the charts 200 of other entities. Furthermore, in some embodiments, the user can selectively restrict the availability of his status information, including some or all of the status indications associated with the user, for display in the charts 200 generated by the status trackers of other entities. For example, the user can selectively restrict certain categories of status indications, such as “Finances,” to a specific group of entities that meet a user-defined certain criteria or clearance level, or to no entities other than the user himself. There can be multiple entities, each with different clearance levels to access the user's status indications and different clearance level titles, such as “Chart Friends”.

Referring now to FIG. 3, further embodiments of the chart 200 are illustrated and discussed. The chart 200 can display additional status information associated with a respective entity in a pop-up field 302. The additional status information can include status indications of many different types, including, but not limited to, text, preselected text phrases, graphical icons, colors, or other visual elements. The additional status information can be associated with other status information, such as a status indication, that is displayed in the chart 200. The pop-up field 302 can be displayed when a user hovers a cursor 300 over an individual cell 206 in the chart 200 displaying a general status indication. For example, as shown in the illustrated embodiment, when the cursor 300 is hovered over a cell 208, which, as noted above, indicates that Robert is not getting much sleep at night by displaying a low numerical value on a 1-10 numerical ranking scale, the pop-up field 302 is displayed to present status information indicating that Robert isn't getting much sleep because he's working on a “big project.”

Some embodiments of the chart 200 display a pop-up field 302 when a cursor 300 is hovered over any part of the chart 200 to provide additional status information associated with each status indication displayed in the chart 200. Other embodiments may replace a general status indication displayed in a cell 206 with more detailed status information when a cursor 300 is hovered over the cell 206.

In some embodiments, some or all of the pop-up fields 302 can be edited by a user. For example, where the user is one of the selected entities, the pop-up fields 302 associated with the cells 206 associated with the user can be edited by the user. The additional status information entered into the pop-up field 302 can be collected and displayed in the charts 200 of other entities. Furthermore, in some embodiments, the user can selectively restrict the availability of his additional status information for display in charts 200 generated by the status trackers of other entities. For example, the user can restrict certain additional status information, such as additional status information associated with certain categories of status indications, such as “Finances,” to a specific group of entities that meet certain user-defined criteria or clearance levels, or to no entities other than the user himself. There can be multiple entities, each with different clearance levels to the user's status information and different clearance level titles, such as “Chart Friends”.

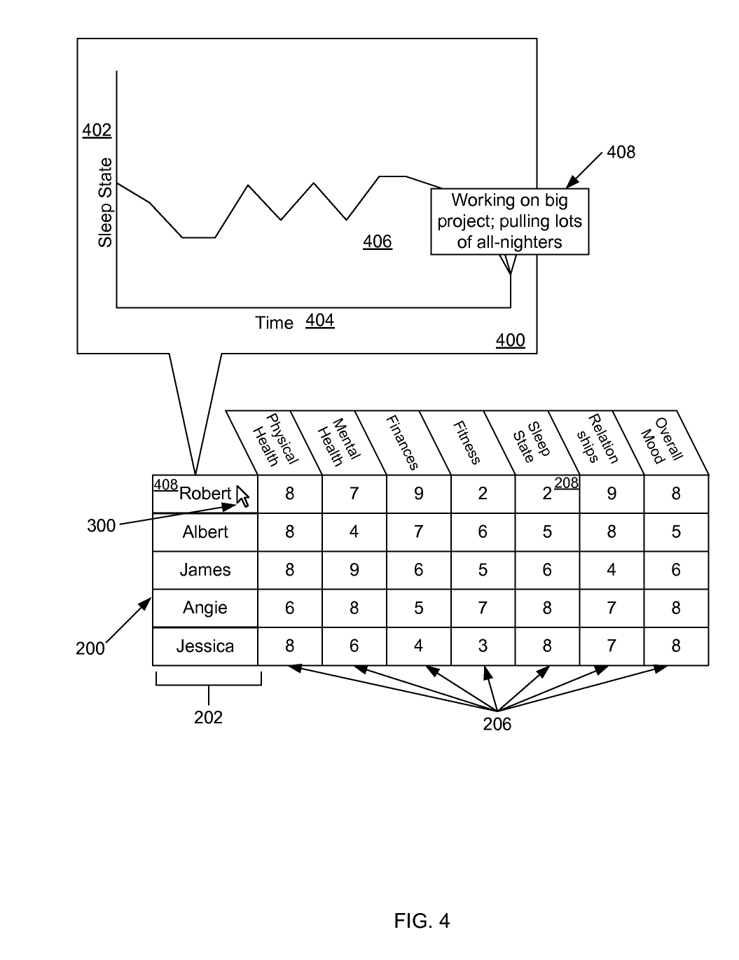

Referring now to FIG. 4, embodiments of a pop-up graph 400 are illustrated and discussed. The pop-up graph 400 can display the variation of status information associated with one or more respective entities against one or more variables, including, but not limited to, time. In the illustrated embodiment, a line graph 406 tracks the variation of a status indication associated with Robert's “Sleep State”, which is normally displayed in cell 208, on a y-axis 402 against time on an x-axis 404. Other status information may be tracked against other variables. For example, the pop-up graph 400 may track the variation of all status indications associated with one of the selected entities over time; alternatively, the pop-up graph 400 may track the variation of all status indications associated with a particular status over time. In addition, the pop-up graph 400 can be represented in other forms, including but not limited to graphical charts, pie charts, bar diagrams, line graphs, or other types of charts or graphs. In some embodiments, the pop-up graph 400 is displayed when a cursor 300 is hovered over an identifier 202 for a respective entity. For example, in the illustrated embodiment, the pop-up graph 400 is displayed when the cursor 300 is hovered over the indicator associated with Robert 408. The status indications tracked by the pop-up graph 400, the type of graph displayed, and the variable against which the status indications will be tracked, can be preselected by the user or be determined by default as default status indications, which can be customized and stored as altered status indications. In other embodiments, pop-up graphs 400 can be displayed concurrently for multiple entities upon activation by the user, either by hovering the cursor 300 over a part of the chart 200, by taking some other action, including but not limited to selecting a button associated with the chart 200, entering a series of keystrokes, or the like.

In some embodiments, the pop-up graph 400 can be displayed independent of chart 200. For example, the pop-up graph 400 can be displayed on a webpage by clicking a button, link, icon, or some other element. In some embodiments, the pop-up graph 400 can display status indications for the user. For example, the pop-up graph 400 can display a user's own status indications and can be displayed by any visitor to a webpage, including but not limited to the user himself, by accessing an element. The webpage can be a webpage of the user's, or it can be another webpage. Furthermore, in some embodiments, the pop-graph 400, displaying a user's own status indications on a webpage, can be displayed automatically to any visitor to the webpage. The status information in the pop-up graph 400, unless displayed to Claim Friends only, can be viewed by any visitor to the webpage, including visitors that either do not use the Status Tracker system or display different status information in their own pop-up graphs 400.

In some embodiments, a pop-up graph 400 can display additional status information in a pop-up field 408. For example, where a cell 208 displaying status indication features additional status information, the additional status information can be displayed in the pop-up chart 400 as a pop-up field 408. Pop-up fields 408 can be displayed through various means, including, but not limited to, automatically upon display of a pop-up graph 400, upon hovering cursor 300 over a data point on the line graph 406, or by clicking a button, icon, link, or some other element. In some embodiments, a pop-up field 408 can be added to a pop-up graph 400 by an entity or user. For example, a user can add additional status information to a new pop-up field 408 on a pop-up graph 400 that displays status indications of the user by hovering a cursor 300 over a data point on the line graph 406, clicking on the data point, or taking some other action. The additional status information can be added to the pop-up field 408 as text, a graphical icon, or some other element.

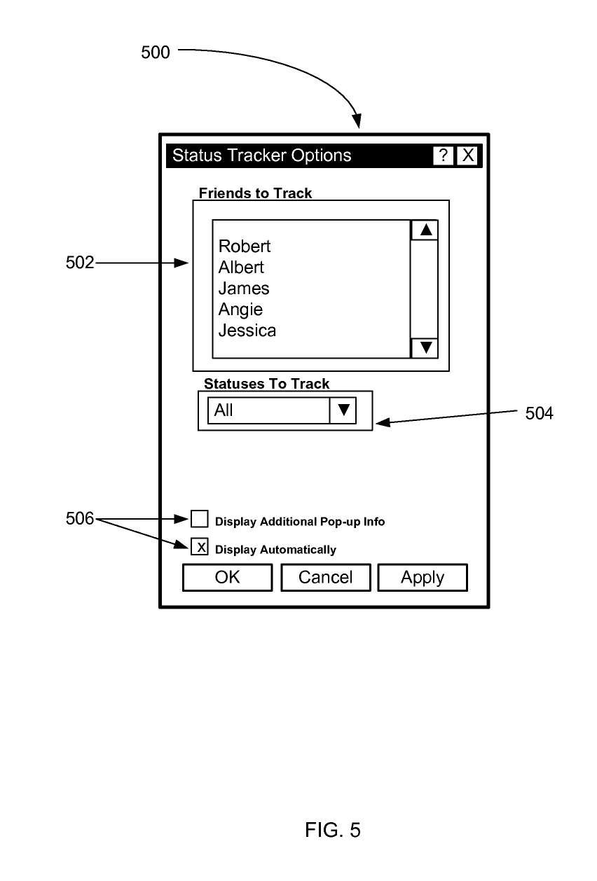

Referring to FIG. 5, embodiments of a control window 500 are illustrated and discussed. The control window 500 enables a user to select the entities to be tracked by the Status Tracker via an entity selection field 502. The control window 500 can also include a status category selection field 504 enabling a user to select the status categories that are to be tracked by the Status Tracker. Additional embodiments of the control window 500 can include either, both, or neither of selection fields 502 and 504. Other embodiments can include selection buttons 506 that can be used to enable or disable functions including, but are not limited to, pop-up fields and automatic activation of the Status Tracker upon webpage initialization.

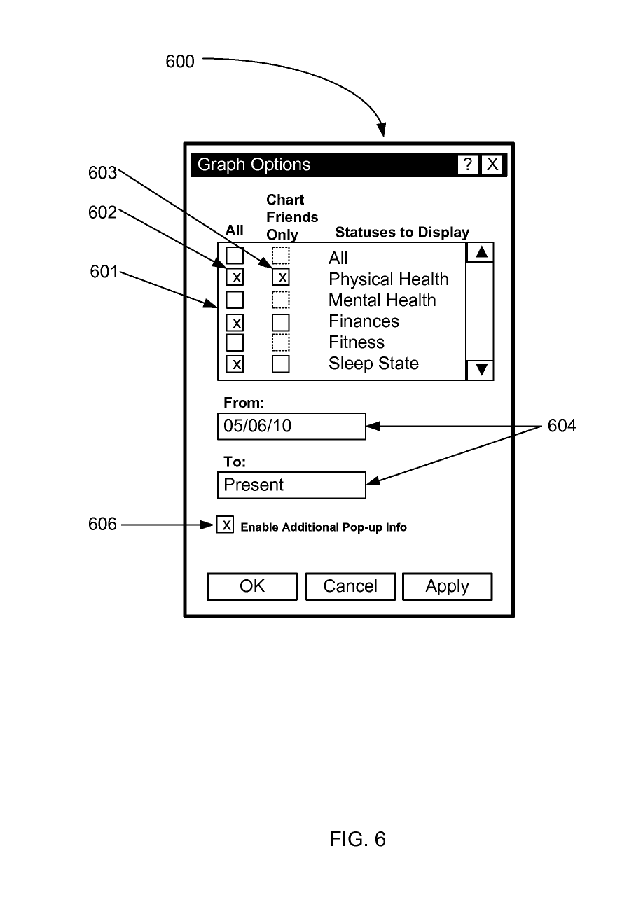

Referring to FIG. 6, embodiments of a control window 600 are illustrated and discussed. In some embodiments, a control window 600 enables a user to select the status information that is displayed in the pop-up graph 400, shown in FIG. 4. The control window 600 can include a status category selection field 601 enabling a user to select the status categories that are to be displayed in the pop-up graph 400. Multiple status categories may be selected in the status category selection field 601. In some embodiments, status categories can be selected via a selection button 602. In addition, in some embodiments, the display of certain selected status categories can be restricted to certain groups of entities, such as Chart Friends, via a second selection button 603. Additional embodiments of the control window 600 can include a timeline field 604 that can enable a user to restrict the amount of time against which the selected status indications are graphed. Other embodiments can include selection buttons 606 that can be used to enable or disable functions including, but are not limited to, pop-up fields.

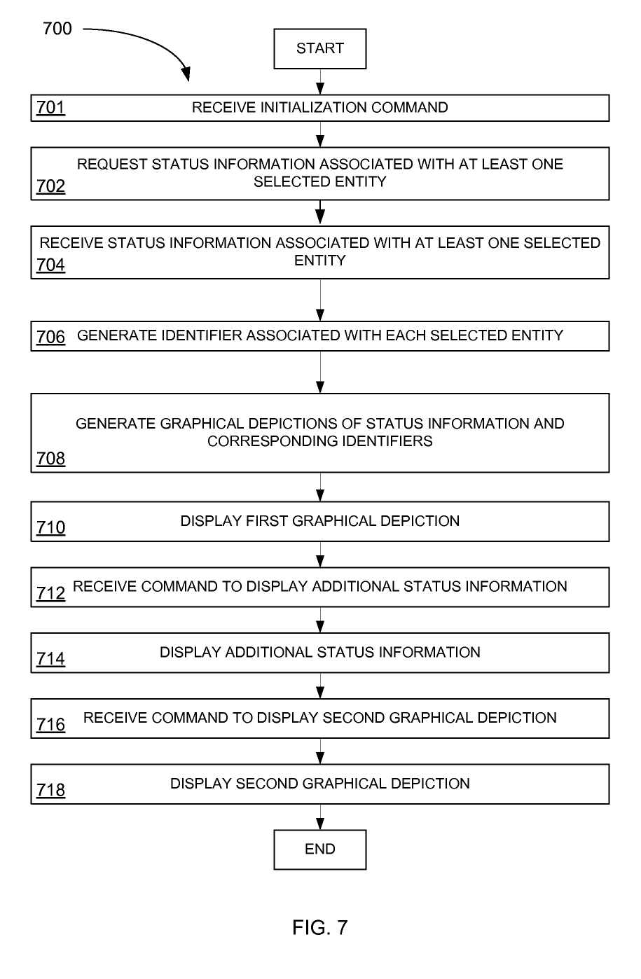

FIG. 7 is a flow diagram illustrating an embodiment of a method 700 performed by Status Tracker 114, shown in FIG. 1. The method 700 includes receipt of a command to initialize, as shown in block 701. The command can be the command to initialize the webpage, or it can be a separate command to initialize the method 700 only. The command to initialize can be generated by the webpage or website code, or it can be generated by a user. Alternatively, the command to initialize can be generated by another source, including, but not limited to, an application running on a mobile device, or a program on a server.

As shown in block 702, the method 700 includes a request of status information associated with a least one selected entity of a set of selected entities. The set of selected entities can be chosen by a user prior to the receipt of the initialization command in block 701. The method 700 can include requesting status information associated with the selected entities from several sources, including but not limited to other websites, the server or servers storing information for the entities' webpages or the website, or other servers. In addition, the method 700 can include requesting any or all status information associated with the selected entities, or the method 700 may include requesting only a selected set of status information associated with the entities. The selected status information may be determined by a user, or it may be determined as a default setting, subject to customization. In some embodiments, the method 700 may include having default status indications and only requesting status indications that are not at default values. For example, all status indications associated with every selected entity that are numerical values on a ranking scale of 1-10 (10 being the highest) may have a default value of 8.5, and the method 700 may include requesting all status information that is not a status indication at a value of 8.5. In some embodiments, default status indications can be altered to become altered status indications. The altered status indications can be stored. As shown in block 704, the method 700 can include receiving at least some status information associated with at least one selected entity.

As shown in block 706, the method 700 can include generating identifiers associated with each selected entity. Alternatively, the method 700 can include receiving identifiers generated by other sources; including, but not limited to, the selected entities themselves, the selected entities' Status Trackers, or the website. The identifiers might be generated by default and be customizable by the entities. The method 700 may include receiving entity-generated or website-generated identifiers in combination with, or independently of, the requested status information. As shown in block 708, the method 700 can include generating graphical depictions of the requested status information and corresponding identifier associated with each selected entity. The method 700 might include using all of the status information that is received in block 704; it might also include using only selected status information. As noted above, the selected status information may be determined by a user, or it may be determined by method 700 as a default setting, subject to customization. The graphical depictions generated can include, but are not limited to, first graphical depictions, second graphical depictions, and fields for displaying additional status information. As shown in block 710, the method 700 can include displaying the first graphical depiction.

As shown in block 712 and 714, the method 700 can include displaying additional status information in response to a command to do so. As discussed above, the additional status information displayed can be, but is not limited to, a single status indication associated with a single selected entity. As also discussed above, the command to display the additional status information can be an automatic command generated by a cursor hovering over a specific status indication associated with a specific selected entity, or it can be generated by some other event, including but not limited to a cursor hovering over a header for a specific status indication, an identifier associated with a selected entity, or any part of the first graphical depiction. In addition, the additional status information can be displayed in response to a user input, including but not limited to the user clicking a button on the webpage or first graphical depiction. Also, the additional status information may be displayed in a pop-up field, or it may be displayed in some other manner, including but not limited to replacing the status indication originally displayed in the first graphical depiction. As shown in blocks 716 and 718, the method 700 can include displaying one or more second graphical depictions in response to a command to do so. As discussed above, the second graphical depiction displayed can be, but is not limited to, a graph tracking the variation of status information, such as one or more status indications, associated with one or more selected entities against a variable. As also discussed above, the command to display one or more second graphical depictions can be an automatic command generated by a cursor hovering over an identifier associated with a specific entity, or it can be generated by some other event, including but not limited to a cursor hovering over a header for a specific status indicator, or any part of the first graphical depiction. In addition, the second graphical depiction can be displayed in response to a user input, including but not limited to the user clicking a button on the webpage or first graphical depiction. Also, the second graphical depiction may be displayed in a pop-up field, or it may be displayed in some other manner, including but not limited to replacing the first graphical depiction on the webpage or displaying the second graphical depiction in a new window of a user's web browser.

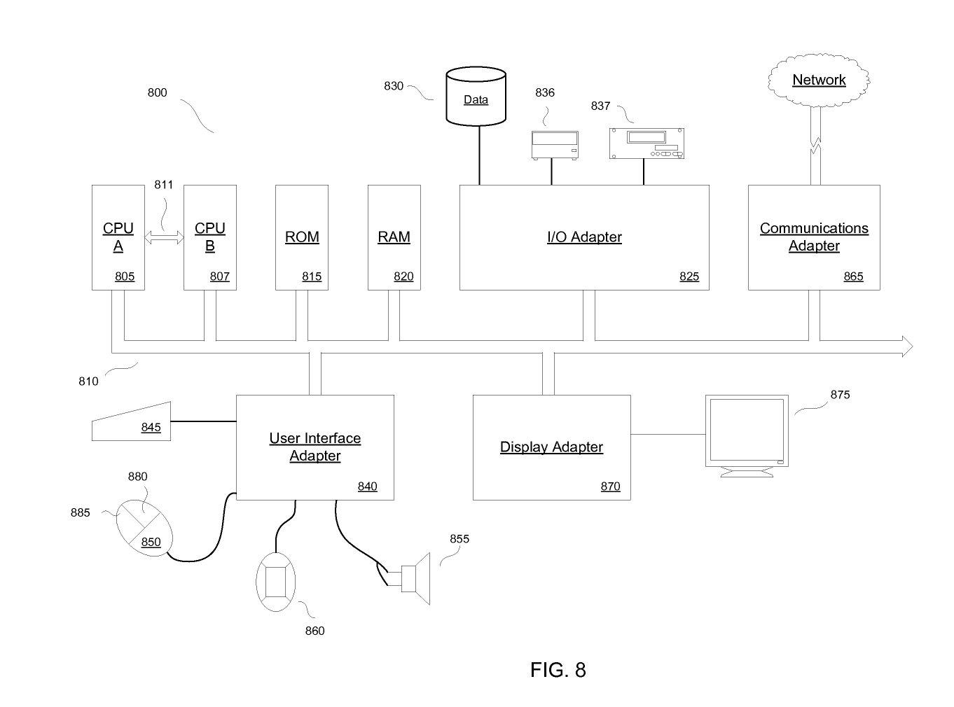

Referring now to FIG. 8, a high-level block diagram of a processing system is illustrated and discussed. The processing system 800 includes one or more central processing units, such as a CPU A 805 and CPU B 807, which may be conventional microprocessors interconnected with various other units via at least one system bus 810. The CPU A 805 and CPU B 807 may be separate cores of an individual, multi-core processor, or individual processors connected via a specialized bus 811. In some embodiments, the CPU A 805 or CPU B 807 may be a specialized processor, such as a graphics processor, other co-processor, or the like.

Processing system 800 includes a random access memory (RAM) 820; read-only memory (ROM) 815, wherein the ROM 815 could also be erasable programmable read-only memory (EPROM) or electrically erasable programmable read-only memory (EEPROM); and input/output (I/O) adapter 825, for connecting peripheral devices such as disk units 830, an optical drive 836, or a tape drive 837 to a system bus 810; a user interface adapter 840 for connecting a keyboard 845, a mouse 850, a speaker 855, a microphone 860, or other user interface devices to the system bus 810; a communications adapter 865 for connecting the processing system 800 to an information network such as the Internet or any of various local area networks, wide area networks, telephone networks, or the like; and a display adapter 870 for connecting the system bus 810 to a display device such as a monitor 875. The mouse 850 has a series of buttons 880, 885 and may be used to control a cursor shown on the monitor 875.

It will be understood that the processing system 800 may include other suitable data processing systems without departing from the scope of the present disclosure. For example, the processing system 800 may include bulk storage and cache memories, which provide temporary storage of at least some program code in order to reduce the number of times code must be retrieved from bulk storage during execution.

Various disclosed embodiments can be implemented in hardware, software, or a combination containing both hardware and software elements. In one or more embodiments, the invention is implemented in software, which includes but is not limited to firmware, resident software, microcode, etc. Some embodiments may be realized as a computer program product, and may be implemented as a computer-usable or computer-readable medium embodying program code for use by, or in connection with, a computer, a processor, or other suitable instruction execution system.

For the purposes of this description, a computer-usable or computer readable medium can be any apparatus that can contain, store, communicate, or transport the program for use by or in connection with an instruction execution system, apparatus, or device. By way of example, and not limitation, computer readable media may comprise any of various types of computer storage media, including volatile and non-volatile, removable and non-removable media implemented in any suitable method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Various embodiments have been described for monitoring the status of selected entities. Other variations and modifications of the embodiments disclosed may be made based on the description provided, without departing from the scope of the invention as set forth in the following claims.

What is claimed is:

1. A method comprising:
obtaining status information associated with each of a selected plurality of entities to be monitored;
the status information associated with a respective entity including a plurality of status indications associated with the respective entity, and
each of the plurality of status indications representing a self-reported status of the respective entity; and
displaying a first graphical depiction including an identifier associated with each of the selected plurality of entities and the plurality of status indications associated with each of the selected plurality of entities.

2. The method of claim 1, further comprising:
displaying a second graphical depiction showing a variation of the status indications associated with a respective entity against a variable, the second graphical depiction displayed in a pop-up field.

3. The method of claim 1, a status indication associated with a respective entity set at a default value.

4. The method of claim 3, further comprising:
altering a default status indication associated with the respective entity; and
storing the altered status indication associated with the respective entity.

5. The method of claim 1, further comprising:
selecting the status information associated with each of a selected plurality of entities from a group consisting of:
physical state, mental state, overall mood, attitude, sleep state, relationship status, and fitness.

6. The method of claim 1, further comprising:
displaying additional status indications associated with a respective entity in a pop-up field when a cursor hovers over a status indication displayed in the first graphical depiction.

7. The method of claim 1, further comprising:
selectively restricting a display of at least one status indication associated with a respective entity based on at least one clearance level associated with the status indication.

8. A computer-readable medium tangibly embodying a program of computer executable instructions, the program of instructions comprising:
At least one instruction to obtain status information associated with each of a selected plurality of entities to be monitored;
the status information associated with a respective entity including a plurality of status indications associated with the respective entity, and
each of the plurality of status indications representing a self-reported status of the respective entity; and
at least one instruction to display a first graphical depiction, the first graphical depiction including an identifier associated with each of the selected plurality of entities and the plurality of status indications associated with each of the selected plurality of entities.

9. The computer readable medium of claim 8, the program of instructions further comprising:
at least one instruction to display a second graphical depiction showing a variation of the status indications associated with a respective entity against a variable, the second graphical depiction displayed in a pop-up field.

10. The computer readable medium of claim 8, the program of instructions further comprising at least one instruction to set a status indication associated with a respective entity at a default value.

11. The computer readable medium of claim 10, the program of instructions further comprising:
at least one instruction to alter a default status indication associated with the respective entity; and
at least one instruction to store the altered status indication associated with the respective entity.

12. The computer readable medium of claim 8, the program of instructions further comprising:
at least one instruction to select the status information associated with each of a selected plurality of entities from a group consisting of:
physical state, mental state, overall mood, attitude, sleep state, relationship status, and fitness.

13. The computer readable medium of claim 8, the program of instructions further comprising:
at least one instruction to display additional status indications associated with a respective entity in a pop-up field when a cursor hovers over a status indication displayed in the first graphical depiction.

14. The computer readable medium of claim 8, the program of instructions further comprising:
at least one instruction to display the first graphical depiction in association with initializing a webpage.

15. An apparatus comprising:
a device configured to:
obtain status information associated with each of a selected plurality of entities to be monitored,
the status information associated with a respective entity including a plurality of status indications associated with the respective entity, and
each of the plurality of status indications representing a self-reported status of the respective entity, and
display a first graphical depiction including an identifier associated with each of the selected plurality of entities and the plurality of status indications associated with each of the selected plurality of entities.

16. The apparatus of claim 15, the device further configured to:
display a second graphical depiction showing a variation of the status indications associated with a respective entity against a variable, the second graphical depiction displayed in a pop-up field.

17. The apparatus of claim 15, the device further configured to set a status indication associated with a respective entity at a default value.

18. The apparatus of claim 17, the device further configured to:
alter a default status indication associated with the respective entity; and
store the altered status indication associated with the respective entity.

19. The apparatus of claim 15, the device further configured to:
select the status information associated with each of a selected plurality of entities from a group consisting of:
physical state, mental state, overall mood, attitude, sleep state, relationship status, and fitness.

20. The apparatus of claim 15, the device further configured to:
display additional status indications associated with a respective entity in a pop-up field when a cursor hovers over a status indication displayed in the first graphical depiction.
